(19) United States
(12) Patent Application Publication
(10) Pub. No.: US 2026/0249191 A1
(43) Pub. Date: Aug. 27, 2026

(54) CONNECTIVITY PLATFORM RESOURCE FOR TRANSFORMATIONS INTO MULTIPLE IN-GAME RESOURCES

(71) Applicant: Games2Coins, Austin, TX (US)

(72) Inventors: Manning Reynolds Field, Austin, TX (US); Tawsif Khan, Austin, TX (US); Beau L. Button, Austin, TX (US)

(21) Appl. No.: 19/181,921

(22) Filed: Apr. 17, 2025

Related U.S. Application Data
(63) Continuation-in-part of application No. 19/061,307, filed on Feb. 24, 2025.

(51) Int. Cl. A63F 13/58

(52) U.S. Cl. CPC A63F 13/58

(57) ABSTRACT

Disclosed herein are systems, methods, and non-transitory, computer-readable storage media for obtaining a connectivity platform resource that may be transformed into one or more in-game resources. A connectivity platform receives a first transformation request and detects that a first amount of a real-world resource has been added to a first electronic repository in response to the request. The platform determines a first transformation rate between the real-world resource and the connectivity platform resource and modifies a resource allocation count based on the first amount of the real-world resource and the first transformation rate. The connectivity platform determines a second transformation rate between the connectivity platform resource and a second in-game resource. The platform generates a second transformation request based on the resource allocation count and second transformation rate and transmits the request.

### CROSS-REFERENCE TO RELATED APPLICATION(S)

The present application is a continuation-in-part of U.S. patent application Ser. No. 19/061,307, filed on Feb. 24, 2025, the entire contents of which are incorporated herein by reference.

### SUMMARY

Many video games include in-game virtual resources that may be converted into other in-game resources (e.g., objects within the game, such as playable characters, items, and cosmetic tokens) and vice versa within a closed-loop ecosystem. A closed-loop ecosystem means that, while in-game resources may be converted into one another, these resources cannot generally be converted into any resources outside of the game ecosystem itself. For that reason, any value added into a video game with a closed-loop ecosystem remains within the game indefinitely unless it is removed by the game developers.

In recent years, there has been increasing interest in video games that instead operate with an open ecosystem where players themselves may transform in-game resources of value into other resources having value outside of the game. However, existing technologies for transforming in-game resources into other resources typically offer limited flexibility. These technologies are typically limited to transforming in-game resources stored on a single game platform into a single real-world resource. There is currently no centralized platform for connecting resources within different games and allowing for in-game resources within one game to be transformed into in-game resources of another game in a streamlined manner. There is also no token configured to store value from various sources (e.g., transformations of in-game resources from various games, transformations of real-world resources from various entities) and facilitate conversion of that value into in-game resources within multiple games.

The systems and methods disclosed herein address these deficiencies by providing an integrated connectivity platform including a connectivity platform resource that may be transformed into in-game resources for multiple games. This connectivity platform addresses the flexibility limitations of existing technologies by allowing a user of the connectivity platform to transform in-game resources from one game into in-game resources of another game, e.g., through the intermediary of the connectivity platform resource, which may be a token unique to the connectivity platform. The connectivity platform may also attribute a resource allocation count to a user account associated with an individual user. The resource allocation count may represent an amount of the connectivity platform resource which the user is entitled to transform and may be modified based on the user adding value from various sources (e.g., transformations of in-game or real-world resources). By effectively tracking the amount of the connectivity platform resource associated with each user and allowing multiple resources to be converted into a singular connectivity platform resource, the connectivity platform may facilitate transformations from a variety of sources for a plurality of users while attributing the resulting resources from each transformation request to the appropriate user.

The connectivity platform may perform the following operations when transforming in-game resources into other resources. The connectivity platform may receive a first transformation request to transform one or more in-game resources from a first game into one or more in-game resources in a second game. The first transformation request may include a first game identifier (e.g., a name, icon, or other identifier) associated with the first game and an amount of a first in-game resource to transform. The first transformation request may be received via an application programming interface (API) of a first game platform hosting gameplay services for the first game, and the user may be logged in to a first in-game account within the first game when the request is generated. Additionally or alternatively, the first transformation request may be received from the user while the user is logged into a user account within the connectivity platform. For example, a player of an online game including in-game resources (e.g., Atlas Earth, Fortnite, Roblox) may be logged in to the game platform hosting that game and wish to transform an in-game resource from the game into an in-game resource in a different game (e.g., transform V-Bucks from Fortnite into Robux from Roblox).

After (or in some embodiments before) the connectivity platform receives the request, the connectivity platform may detect that a first amount of a real-world resource has been added to a first electronic repository associated with the connectivity platform. For example, this amount of the real-world resource may be transferred to the electronic repository by the first game platform to cover the expense of the connectivity platform transforming the in-game resource. In some embodiments, detecting the first amount of the real-world resource may include monitoring the electronic repository (e.g., over a network) for changes in real-world resources stored therein and detecting a change in real-world resources associated with the first transformation request. In other embodiments, detecting the amount of the real-world resource may include receiving a notification (e.g., over a network) from the electronic repository that a change in real-world resources within the electronic repository has been made and is associated with the first transformation request.

The connectivity platform may determine a first transformation rate between a connectivity platform resource and the real-world resource. For example, the connectivity platform resource may be a unique token attributed to users of the connectivity platform that is used by the connectivity platform as an intermediary resource for transforming in-game resources for a plurality of games into one another and/or to transform other resources (e.g., real-world resources) into in-game resources for a plurality of games. The first transformation rate may indicate an amount of the real-world resource equivalent in value to one unit of the connectivity platform resource and thereby be used as the basis for transformations between the two resources. After determining the first transformation rate, the connectivity platform may modify a resource allocation count based on the second amount of the real-world resource and the first transformation rate. For example, the resource allocation count may indicate an amount of the connectivity platform resource attributed to the user's account within the connectivity platform.

The connectivity platform may determine a second transformation rate between the connectivity platform resource and an in-game resource within a second game. In some embodiments, the second game may be selected via a selection graphical user interface (GUI) the connectivity platform causes to be displayed to the user, which may include a game identifier from one or more games that the user may select for a transformation. The second transformation rate may indicate an amount of the connectivity platform resource equivalent in value to one unit of a second in-game resource within the second game and thereby be used as the basis for transformations between the two resources. In some embodiments, the second transformation rate may be based on a number of selections of the second game or a transformation enhancement applied to the second game (e.g., a limited-time promotion or other enhancement for making a certain transformation).

Based on determining the second transformation rate, the connectivity platform may generate, based on the resource allocation count and the second transformation rate, a second transformation request. The second transformation request may be a request for the second game platform to link an amount of the second in-game resource with a second in-game account and may transmit the second transformation request to the second game platform. For example, the second transformation request may be a request to transform an amount of the connectivity platform resource or an in-game resource from another game into an amount of the second in-game resource. When the request is received by the second game platform, the request may signal to the second game platform that the game platform has been compensated for disbursing those in-game resources. In some embodiments, the second transformation request may include a specification of a type of the second in-game resource, the amount of the second in-game resource, the second in-game account, and the first electronic repository. In some embodiments, the second transformation request may be transmitted to an API of the second game platform that causes a transfer of a second amount of the real-world resource from the first electronic repository to a second electronic repository that is associated with the second game platform (e.g., as compensation for the game platform partnering with the connectivity platform).

The second game platform, in conjunction with the connectivity platform, may disburse the second in-game resource in different ways, depending on the embodiment. For example, the second game platform may generate a symbolic code (e.g., a gift card code or coupon code) that, when input into the second game platform by a user logged in to an in-game account, will attribute the requested second in-game resource to that in-game account. Continuing with the same example, the symbolic code may be received by the connectivity platform from the second game platform, and the connectivity platform may then generate a presentation of the symbolic code to the user. As another example, the second game platform may initially attribute the second in-game resource to a third in-game account associated with the connectivity platform itself, and then the connectivity platform may generate a transfer request. The transfer request may be a request to transfer the amount of the second in-game resource from the second transformation request from the third in-game account to the user's second in-game account, thereby ultimately attributing the in-game resource to the user.

In some embodiments, the connectivity platform may modify the resource allocation count based on the second transformation rate and the amount of the second in-game resource requested in the second transformation request. For example, the connectivity platform may thereby decrease the amount of the connectivity platform resource attributed to the user in proportion to the value of the real-world resources spent to link the user's second in-game account with the amount of the second in-game resource. In some embodiments, modifying the resource allocation count may cause the connectivity platform to display a transformation summary GUI summarizing the transformation of the connectivity platform resource into the second in-game resource.

Additionally or alternatively, the connectivity platform may cause the display of a transformation GUI for transforming one or more resources. The transformation GUI may include a list of games including a game identifier for one or more games and/or a display of various transformation rates. For example, transformation rates between a connectivity platform resource and various in-game resources (e.g., V-Bucks, Robux) may be displayed, as well as a transformation rate between two in-game resources (e.g., for transforming V-Bucks directly into Robux). In some embodiments, the first transformation request may be received from the user via a selection by the user of a game identifier from the list of games.

In some embodiments, the list of games may include an unlinked game for which the user does not have an existing in-game account. The unlinked game may be selected by the connectivity platform from a games database within the connectivity platform based on a number of previous selections of the unlinked game and/or based on a similarity between the unlinked game and a game for which the user does have an existing in-game account. For example, the similarity may be a measured similarity between the demographics of players of the two games (e.g., age, sex, race, or income) and/or may be membership in the game genre of game (e.g., platformer, shooter, or puzzle).

In some embodiments, the connectivity platform may transform resources from sources other than games into the connectivity platform resource. For example, the connectivity platform may be in communication with a transformation platform from which the connectivity platform receives a real-world resource. The transformation platform may be a platform for transforming resources into on-chain resources and executing blockchain operations related to the transfer of on-chain resources, such as the transfer of an on-chain resource from one cryptography-based storage application to another. Additionally or alternatively, the connectivity platform may enable a user to directly transform the real-world resource into the connectivity platform resource. For example, the connectivity platform may cause display of a real-world resource transformation GUI which the user may use to select an additional amount of the connectivity platform resource to receive in a transformation of the real-world resource.

Various other aspects, features, and advantages of the system will be apparent through the detailed description and the drawings attached hereto. It is also to be understood that both the foregoing general description and the following detailed description are examples and not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 is an example environment for transforming in-game resources from a first game into in-game resources for a second game.

FIG. 2 is an example transformation summary graphical user interface (GUI) summarizing the transformation of a connectivity platform resource into a second in-game resource.

FIG. 3 is an example transformation GUI for transforming one or more resources.

FIG. 4 is an example real-world resource transformation GUI for selecting an additional amount of a connectivity platform resource to receive in a transformation of a real-world resource.

FIG. 5 is an example selection GUI for selecting games in which to receive in-game resources.

FIG. 6 is an illustrative diagram for an example computing system.

FIG. 7 is an illustrative diagram for a decentralized environment for performing blockchain functions or operations.

FIG. 8 is a flowchart of operations for transforming in-game resources from one game into in-game resources in another game.

### DETAILED DESCRIPTION

### Example Transformation Environment

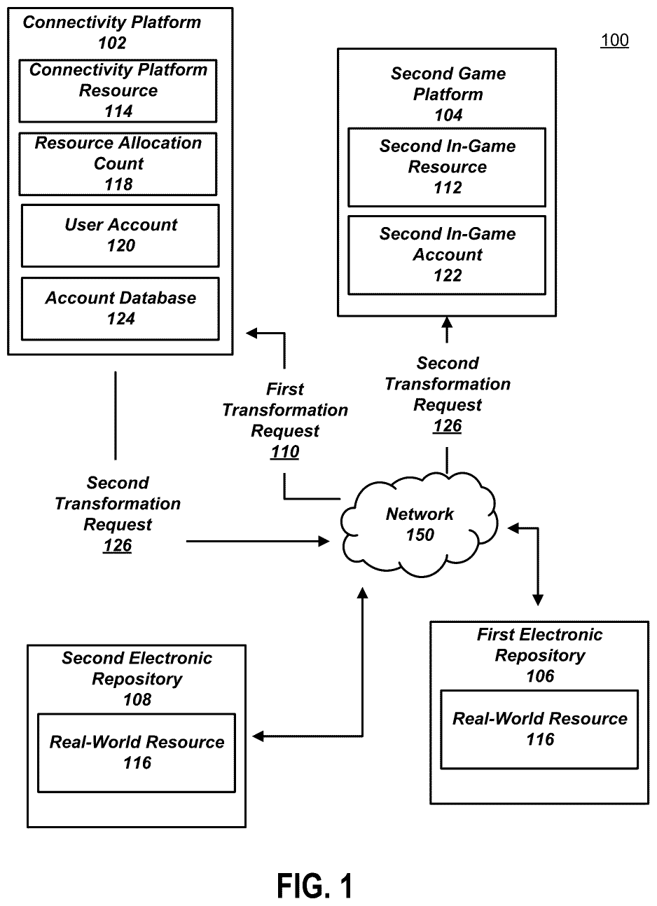

FIG. 1 is an example of environment 100 for transforming in-game resources from a first game into in-game resources in a second game. Environment 100 includes connectivity platform 102, second game platform 104, first electronic repository 106, second electronic repository 108, first transformation request 110, second transformation request 126, and network 150. Connectivity platform 102 may execute instructions for transmitting a second transformation request 126 to second game platform 104. Connectivity platform 102 may include software, hardware, or a combination of the two. For example, connectivity platform 102 may be hosted on a physical server or a virtual server that is running on a physical computer system. In some embodiments, connectivity platform 102 may be configured on a user device (e.g., a laptop computer, a smartphone, a desktop computer, an electronic tablet, or another suitable user device).

In some embodiments, connectivity platform 102 receives first transformation request 110 over network 150. Network 150 may be a local area network, a wide area network (e.g., the Internet), or a combination of the two. First transformation request 110 may be a request to transform one or more in-game resources from a first game into second in-game resource 112 in a second game (e.g., a game hosted by second game platform 104). Second in-game resource 112 may be an object within a game that may be interacted with by a player of the game, such as a playable character, an item, a cosmetic token, and/or fungible in-game currency that may be exchanged for another in-game resource. In some embodiments, first transformation request 110 may include a first game identifier (e.g., a name, icon, or other identifier) associated with the first game from which the in-game resources are being transformed and/or an amount of a first in-game resource from the first game (e.g., a quantity of in-game currency) to transform.

Additionally or alternatively, first transformation request 110 may be a request to transform one or more in-game resources into connectivity platform resource 114. Connectivity platform resource 114 may be a resource representing value within connectivity platform 102 that users of connectivity platform 102 may transform into in-game resources for various games. In some embodiments, connectivity platform resource 114 may be a token attributed to users of connectivity platform 102 and transformable into in-game resources for a plurality of games. The token may be unique to connectivity platform 102 and operate as an intermediary resource enabling transformations between various resources (e.g., transformations of in-game resources from various games, transformations of real-world resources from various sources) via connectivity platform 102. For example, connectivity platform 102 may include a proprietary connectivity platform resource called “Pix,” which is a token that may be transformed into popular in-game currencies such as V-Bucks or Robux (and vice versa). While Pix may be transformed into these in-game currencies and/or other resources (e.g., other in-game or real-world resources) and vice versa, the Pix token itself may not be used or stored outside of connectivity platform 102.

First electronic repository 106 may store resources of value on behalf of entities associated with first electronic repository 106 (e.g., individuals, organizations, and/or platforms such as connectivity platform 102 and second game platform 104). In some embodiments, first electronic repository 106 may store real-world resource 116, which may be a fungible object of value used for transactions in the physical world (e.g., as opposed to a virtual environment like an online game). For example, real-world resource 116 may be a government-backed fiat currency (e.g., USD). In these and other embodiments, first electronic repository 106 may be associated with connectivity platform 102.

In some embodiments, connectivity platform 102 detects that an amount of real-world resource 116 has been added to first electronic repository 106. For example, detecting the amount of real-world resource 116 may include monitoring first electronic repository 106 (e.g., via connecting to first electronic repository 106 over network 150) for changes in real-world resource 116 stored therein and detecting a change in real-world resource 116 associated with first transformation request 110. Continuing with the same example, detecting the change may include identifying that the change is associated with the first game identifier and the amount of the first in-game resource specified by first transformation request 110, thereby allowing connectivity platform 102 to associate the amount of real-world resource 116 with first transformation request 110. As another example, detecting the amount of real-world resource 116 may include receiving a notification from first electronic repository 106 that a change in real-world resource 116 within first electronic repository 106 has been made. Continuing with this example, the notification may include an indication that the change is associated with the first game identifier and the amount of the first in-game resource specified by first transformation request 110, thereby allowing connectivity platform 102 to associate the amount of real-world resource 116 with first transformation request 110.

In some embodiments, connectivity platform 102 may determine a first transformation rate between connectivity platform resource 114 and real-world resource 116. For example, the first transformation rate may indicate an amount of real-world resource 116 equivalent in value to one unit of connectivity platform resource 114 and may thereby be used as the basis for transformations between the two resources. In some embodiments, the first transformation rate may be fixed by an entity operating connectivity platform 102. In other embodiments, the first transformation rate may be dynamically updated by connectivity platform 102 based on usage of connectivity platform resource 114. For example, the first transformation rate may be dynamically updated based on a number of transformations completed using connectivity platform resource 114 and/or a total amount of connectivity platform resource 114 available to users of connectivity platform 102.

In some embodiments, connectivity platform 102 may include resource allocation count 118. Resource allocation count 118 may be a numerical representation of the amount of connectivity platform resource 114 within connectivity platform 102 attributed to a user (e.g., an amount of connectivity platform resource 114 attributed to the user and/or an amount for which the user is entitled to direct the usage/transformation). For example, when an amount of real-world resource 116 associated with first transformation request 110 is added to electronic repository 106, a user of connectivity platform 102 may be associated with first transformation request 110. Continuing with the same example, the user may be associated with first transformation request 110 by virtue of logging in to a first in-game account for the first game via a first game platform hosting the first game and sending the first transformation request to connectivity platform 102 (e.g., via an API of the first game platform) while logged in to the first in-game account. The first in-game account may be an account associated with the first game platform that may grant access to the user to play the first game hosted by the first game platform.

In such an example, the user, as the individual whose resources are transformed in first transformation request 110, may be entitled to an amount of connectivity platform resource 114 representing some or all of the value of the one or more in-game resources transformed. Thus, connectivity platform 102 may track the user's entitlement by modifying resource allocation count 118 associated with the user. For example, resource allocation count 118 may be modified based on the first amount of real-world resource 116 and/or the first transformation rate, thereby modifying resource allocation count 118 proportionally to the amount of real-world resource 116 received by connectivity platform 102 in first electronic repository 106. Continuing with the same example, an amount of connectivity platform resource 114 corresponding to resource allocation count 118 may then be attributed to the user. Tracking resource allocation count 118 associated with the user allows connectivity platform 102 to include amounts of connectivity platform resource 114 attributed to multiple users of connectivity platform 102 at once while allowing connectivity platform 102 to facilitate direction by each user of connectivity platform 102 of the usage or transfer of an amount of connectivity platform resource 114 to which each user is entitled.

In some embodiments, connectivity platform 102 includes user account 120 associated with a user of connectivity platform 102. User account 120 may be associated with a user and used by the user to access connectivity platform 102 and send/receive transformation requests associated with in-game resources, real-world resources, and/or connectivity platform resource 114 via connectivity platform 102. For example, an amount of connectivity platform resource 114 corresponding to resource allocation count 118 may be attributed to the user by attributing that amount to user account 120, and the user may execute transformations using that amount of connectivity platform resource 114 while logged in to user account 120.

Second game platform 104 may host gameplay services for a second game (e.g., an online game accessible by a user via network 150). Second game platform 104 may include software, hardware, or a combination of the two. For example, second game platform 104 may be hosted on a physical server or a virtual server that is running on a physical computer system. In some embodiments, second game platform 104 may be configured on a user device (e.g., a laptop computer, a smartphone, a desktop computer, an electronic tablet, or another suitable user device). In some embodiments, second game platform 104 may include second in-game resource 112, which may have the same or generally similar features as the in-game resources described above. In these and other embodiments, second game platform 104 may include second in-game account 122, which may be an account associated with the user and with second game platform 104 that may grant access to the user to play the second game hosted by second game platform 104.

In some embodiments, connectivity platform 102 determines a second transformation rate between connectivity platform resource 114 and second in-game resource 112 within the second game. For example, analogously to the first transformation rate, the second transformation rate may indicate an amount of second in-game resource 112 equivalent in value to one unit of connectivity platform resource 114 and may thereby be used as the basis for transformations between the two resources. In some embodiments, the second transformation rate may be fixed by an entity operating connectivity platform 102. In other embodiments, the first transformation rate may be dynamically updated by connectivity platform 102 based on interactions between connectivity platform 102 and second game platform 104. For example, the second transformation rate may be based on a number of selections of the second game (e.g., by users of connectivity platform 102) as a target destination game for transforming resources from other sources (e.g., connectivity platform resource 114) into in-game resources of that game. Basing the second transformation rate on the number of selections enables connectivity platform 102 to dynamically adjust the second transformation rate based on the popularity of transforming resources into second in-game resource 112 and thereby recalibrate the incentive of performing such a transformation over time. As another example, the second transformation rate may be based on a transformation enhancement applied to the second game by connectivity platform 102. The transformation enhancement may be an event (e.g., a promotional event, discount event, or other enhancement to the transformation) occurring for a limited duration of time that enhances the resources which may be received by a user for transformations into second in-game resource 112 (e.g., by modifying the second transformation rate to increase the amount of second in-game resource 112 equivalent in value to one unit of connectivity platform resource 114 and/or by enabling an additional resource to be obtained alongside an amount of second in-game resource 112 without the transformation of additional connectivity platform resource 114).

In some embodiments, connectivity platform 102 generates, based on resource allocation count 118 and the second transformation rate, second transformation request 126 for second game platform 104. Second transformation request 126 may be a request to link an amount of second in-game resource 112 with second in-game account 122, thereby allowing the user to access the amount of second in-game resource 112 within the second game. In some embodiments, second transformation request 126 may include a specification of a type of second in-game resource 112 (e.g., an indication of whether second in-game resource 112 is a playable character, fungible in-game currency, or other in-game resource), an amount of second in-game resource 112, second in-game account 122, and/or first electronic repository 106. Specifying each of these in second transformation request 126 enables second transformation request 126 to provide sufficient information to second game platform 104 for second game platform 104 to attribute the amount of second in-game resource 112 to second in-game account 122 (and therefore the user).

In some embodiments, connectivity platform 102 may transmit second transformation request 126 to an API of second game platform 104 (e.g., over network 150). In such embodiments, connectivity platform 102 may cause, via the API, the transfer of a second amount of real-world resource 116 from first electronic repository 106 to second electronic repository 108. Second electronic repository 108 may have the same or a generally similar structure to electronic repository 106, except that second electronic repository 108 is associated with second game platform 104 rather than connectivity platform 102. The second amount of real-world resource 116 may be determined based on the first and second transformation rates and/or may be determined to be equivalent in value to the amount of second in-game resource 112 attributed to second in-game account 122. Thus, second game platform 104 may be compensated for attributing second in-game resource 112 to second in-game account 122 by receiving real-world resource 116 from first electronic repository 106 associated with connectivity platform 102.

In some embodiments, second game platform 104 may not attribute second in-game resource 112 to second in-game account 122 directly but may execute further interactions with connectivity platform 102 in order to finalize this attribution. For example, second game platform 104 may, in response to second transformation request 126, generate a symbolic code that, when input into second game platform 104 by a user logged in to second in-game account 122, may attribute the requested amount of second in-game resource 112 to second in-game account 122. Continuing with the same example, the symbolic code may be sent by second game platform 104 to connectivity platform 102, which may then receive the symbolic code and generate a presentation of the symbolic code to the user. The user may then enter the code while logged in to second in-game account 122 to gain access to the amount of second in-game resource 112. As another example, second game platform 104 may initially attribute the amount of second in-game resource 112 to a third in-game account associated with connectivity platform 102 itself, and then connectivity platform 102 may generate a transfer request to transfer the amount of second in-game resource 112 from second transformation request 126 from the third in-game account to second in-game account 122. Continuing with the same example, the transfer request may include a specification of the amount of second in-game resource 112 to transfer and of the two in-game accounts, enabling second game platform 104 to transfer the appropriate amount of second in-game resource 112 between the accounts. Additionally or alternatively, the transfer request may cause, via an API of second game platform 104, the amount of second in-game resource 112 to be transferred from the third in-game account to second in-game account 122 in response to the transfer request.

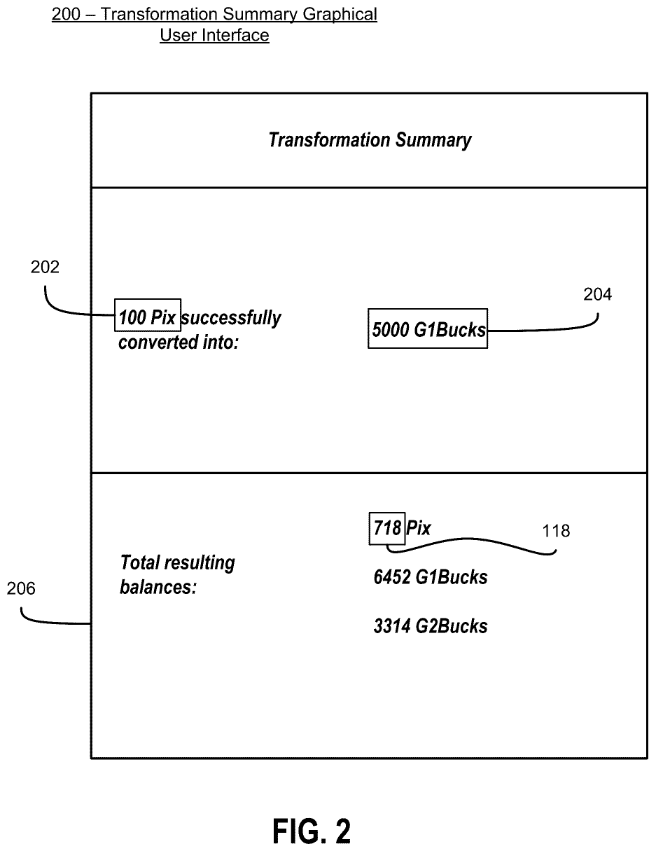

In some embodiments, connectivity platform 102 may modify resource allocation count 118 based on the second transformation rate and the amount of second in-game resource 112 requested in second transformation request 126. In doing so, connectivity platform 102 may avoid transforming more of connectivity platform resource 114 on behalf of the user than the user is entitled to control, allowing connectivity platform 102 to manage transformation requests from multiple users without depleting more than the amount of connectivity platform resource 114 to which each user is entitled. In such embodiments, modifying resource allocation count 118 may cause connectivity platform 102 to display (e.g., to the user associated with second transformation request 126) transformation summary graphical user interface (GUI) 200 summarizing the transformation of connectivity platform resource 114 into second in-game resource 112. An example of such a GUI is illustrated in FIG. 2. Summary GUI 200 may include an indication of resource allocation count 118 after modification, the amount 204 of second in-game resource 112 attributed to second in-game account 122 as a result of second transformation request 126, and/or a spent connectivity platform resource count 202, which is based on the modification to resource allocation count 118 (e.g., by equaling the difference between resource allocation count 118 pre-and post-modification). For example, as illustrated in FIG. 2, a connectivity platform resource called Pix has been transformed into 5000 G1Bucks, which is an in-game resource (e.g., a fungible in-game currency). Continuing with the same example, the transformation into 5000 G1Bucks required 100 Pix to be transformed, as indicated by the spent connectivity platform resource count 202. Further continuing with the same example, resource allocation count 118 now has a value of 718, indicating that the user was attributed 818 Pix before the transformation, which has now decreased to 718 Pix in light of 100 of those Pix being transformed into G1Bucks.

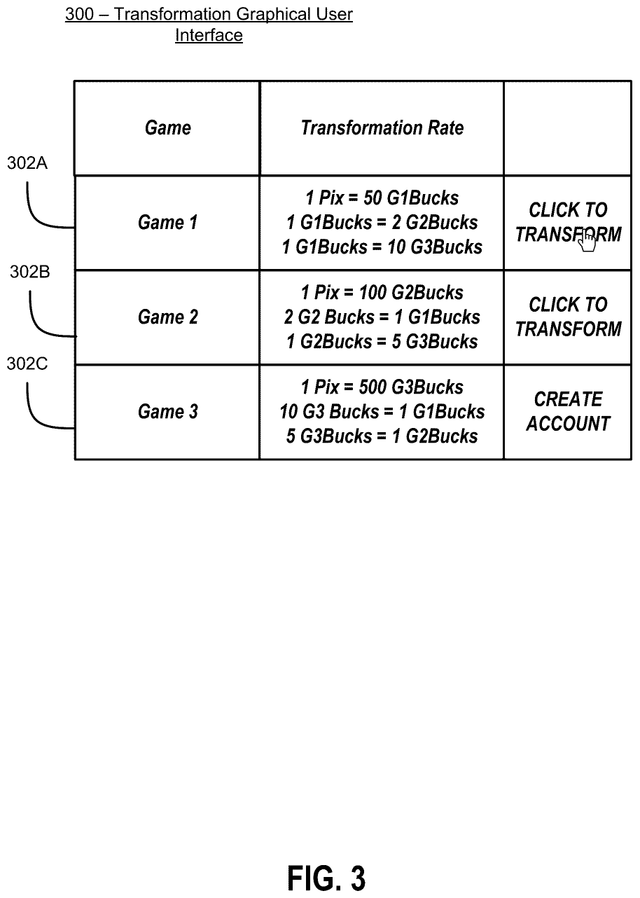

In some embodiments, connectivity platform 102 may cause the display of transformation GUI 300 for transforming one or more resources. An example of such a GUI is illustrated in FIG. 3. The transformation GUI 300 may include a list of games including a game identifier 302A, 302B, 302C for one or more games. The GUI may also include a transformation rate between connectivity platform resource 114 and one or more in-game resources (e.g., resources within the games from the list of games) and/or one or more transformation rates between in-game resources from different games. For example, as illustrated in FIG. 3, the transformation rate between G1Bucks and Pix, a connectivity platform resource, is displayed as well as the transformation rates between G1Bucks and both G2Bucks and G3Bucks, which are in-game resources for Game 2 and Game 3, respectively. In some embodiments, first transformation request 110 may be received from the user via a selection by the user (e.g., by clicking a selection button using a mouse cursor, as illustrated in FIG. 3) of a game identifier from the list of games. In such embodiments, the user may be logged in to user account 120 in order to view the display of transformation GUI 300 and/or select a game identifier 302A, 302B, 302C from the list of games.

In some embodiments, the list of games may include an unlinked game for which the user does not have an existing in-game account. For example, as illustrated in FIG. 3, three game identifiers 302A, 302B, 302C, each for a different game, are included in the list of games. Any of these three games may be selected by the user (e.g., by clicking a selection button using a mouse cursor, as illustrated in FIG. 3), but the list of games indicates that Game 3 is currently an unlinked game, as denoted by the display of “Create Account” instead of “Click to Transform” for Game 3.

In some embodiments, the unlinked game may be selected by connectivity platform 102 from a games database within connectivity platform 102. The games database may be a database for storing various data associated with games that may appear in the list of games and/or that connectivity platform 102 may link to user account 120. The games database may include software, hardware, or a combination of the two. For example, the games database may be a physical server or a virtual server that is running on a physical computer system. In some embodiments, connectivity platform 102 and the games database may reside on the same hardware and/or the same virtual server/computing device. In such embodiments, connectivity platform 102 may select an unlinked game from the games database based on a number of previous selections of the unlinked game. For example, the previous selections may be previous selections by other users of connectivity platform 102 to receive an in-game resource in the unlinked game, thus indicating the unlinked game is popular amongst users of connectivity platform 102 and therefore potentially of interest to the user presently making a selection. Additionally or alternatively, connectivity platform 102 may select an unlinked game based on a similarity between the unlinked game and a game for which the user does have an existing in-game account. For example, the similarity may be a measured similarity between the demographics of players of the two games (e.g., age, sex, race, or income) and/or may be membership in the game genre of game (e.g., platformer, shooter, or puzzle). By selecting based on the similarity, connectivity platform 102 causes display of a game that is likely to have similar gameplay to a game the user already plays and therefore also may potentially be of interest to that user.

In some embodiments, connectivity platform 102 may transform resources from sources other than games into connectivity platform resource 114. For example, connectivity platform 102 may be in communication (e.g., via network 150) with a transformation platform from which the connectivity platform receives real-world resource 116. The transformation platform may be a platform for transforming resources into on-chain resources and executing blockchain operations related to the transfer of on-chain resources, such as the transfer of an on-chain resource from one cryptography-based storage application to another. On-chain resources may be resources hosted on a blockchain, such as cryptocurrencies or nonfungible tokens, and which may be stored in cryptography-based storage applications, such as “cryptographic wallets.” Each cryptography-based storage application may store a private key associated with a corresponding user and may include software, hardware, or a combination of the two. For example, each cryptography-based storage application may include software executed on one or multiple devices or may include hardware such as a physical device. In some cases, a cryptography-based storage application may be software and may be stored in data nodes, and a user of the cryptography-based storage application may access the cryptography-based storage application online, e.g., via a browser. Additionally or alternatively, a cryptography-based storage application may reside on a general-purpose computer or on a special device (e.g., a fob) intended for storing the cryptography-based storage application. For example, the device may store private keys in a memory of the device and allow transactions to be completed on the device itself. Some examples of hardware cryptographic wallets include Ledger® and Trezor®. Software cryptographic wallets may include MetaMask® and others.

Continuing with the same example, the transformation platform may include software, hardware, or a combination of the two. For example, the transformation platform may be hosted on a physical server or a virtual server that is running on a physical computer system. In some embodiments, the transformation platform may be configured on a user device (e.g., a laptop computer, a smartphone, a desktop computer, an electronic tablet, or another suitable user device). In some embodiments, the transformation platform may be hosted on a blockchain and may execute operations on a blockchain node. For example, the transformation platform may be a part of a smart contract or another on-chain program that is being executed by a blockchain node. In some embodiments, the transformation platform may be hosted on an independent computing device and may send requests to the blockchain node to execute instructions (e.g., retrieve cryptographic tokens, mint cryptographic tokens, etc.).

Further continuing with the same example, connectivity platform 102 may receive a notification that a first amount of real-world resource 116 has been added to first electronic repository 106 in response to the transformation platform transforming a second amount of real-world resource 116 into a corresponding set of on-chain resources. This notification may specify the second amount of real-world resource 116 and/or a transformation platform account associated with a user of connectivity platform 102 who initiated the transformation. In response to this notification, connectivity platform 102 may then determine that user account 120 is associated with the transformation platform account, thereby confirming that the user associated with user account 120 is also associated with the transformation executed by the transformation platform. In some embodiments, this determination may be made by searching account database 124 stored in connectivity platform 102 using user account 120 (e.g., using text serving as a username for user account 120 as input for a search query of account database 124). Account database 124 may be a database for storing various data associated with user accounts. Account database 124 may include software, hardware, or a combination of the two. For example, account database 124 may be a physical server or a virtual server that is running on a physical computer system. In such embodiments, connectivity platform 102 and account database 124 may reside on the same hardware and/or the same virtual server/computing device. In other embodiments, account database 124 may be stored within the transformation platform in a similar manner and connectivity platform 102 may search account database 124 via an API of the transformation platform.

Again, continuing with the same example, connectivity platform 102 may modify resource allocation count 118 based on the second amount of real-world resource 116 and the first transformation rate, thereby modifying the amount of connectivity platform resource 114 attributed to the user based on the user's activity within the transformation platform. Doing so enables connectivity platform 102 to incentivize transformations involving on-chain resources on the transformation platform while allowing users to acquire connectivity platform resource 114 from a source other than a game.

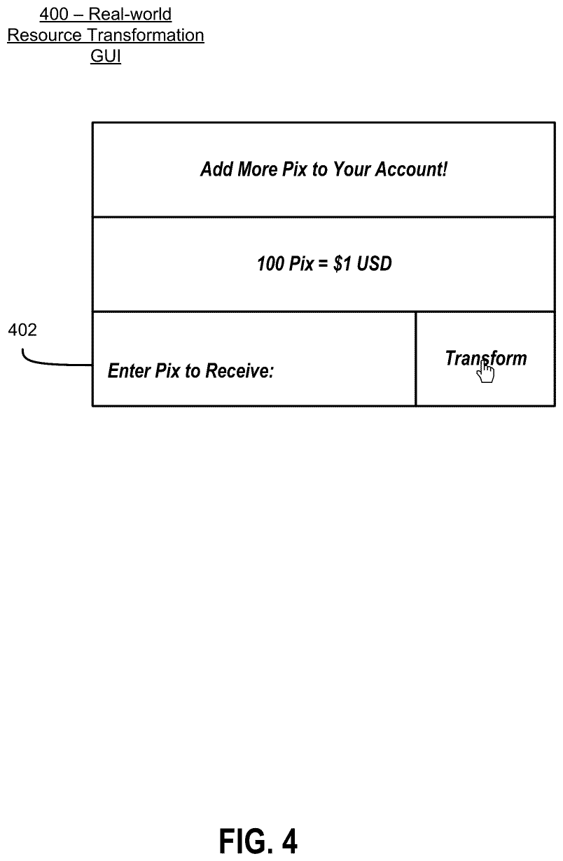

In some embodiments, connectivity platform 102 may enable a user to directly transform real-world resource 116 into connectivity platform resource 114. For example, connectivity platform 102 may cause display of real-world resource transformation GUI 400 for selecting an additional amount of connectivity platform resource 114 to receive in a transformation of real-world resource 116. An example of such a GUI is illustrated in FIG. 4. As illustrated in FIG. 4, real-world resource transformation GUI 400 may include the first transformation rate, indicating to the user an amount of connectivity platform resource 114 that may be obtained by transforming one unit of real-world resource 116. Also as illustrated in FIG. 4, real-world resource transformation GUI 400 may include a selection field 402 for entering an amount of connectivity platform resource 114 to receive by transforming real-world resource 116. Alternatively, selection field 402 may be for entering an amount of real-world resource 116 to be transformed into connectivity platform resource 114. In either alternative, the indicated transformation may be executed by connectivity platform 102 in response to receiving a selection from the user (e.g., by clicking a transformation button using a mouse cursor, as illustrated in FIG. 4). For example, connectivity platform 102 may receive a notification that an amount of real-world resource 116 has been added to first electronic repository 106 (e.g., from an electronic repository associated with the user), with the amount being based on the first transformation rate and the amount of connectivity platform resource 114 indicated by the entry in selection field 402. Connectivity platform 102 may then modify resource allocation count 118 based on the amount of connectivity platform resource 114, reflecting that the user has directly transformed real-world resource 116 in order to receive additional connectivity platform resource 114.

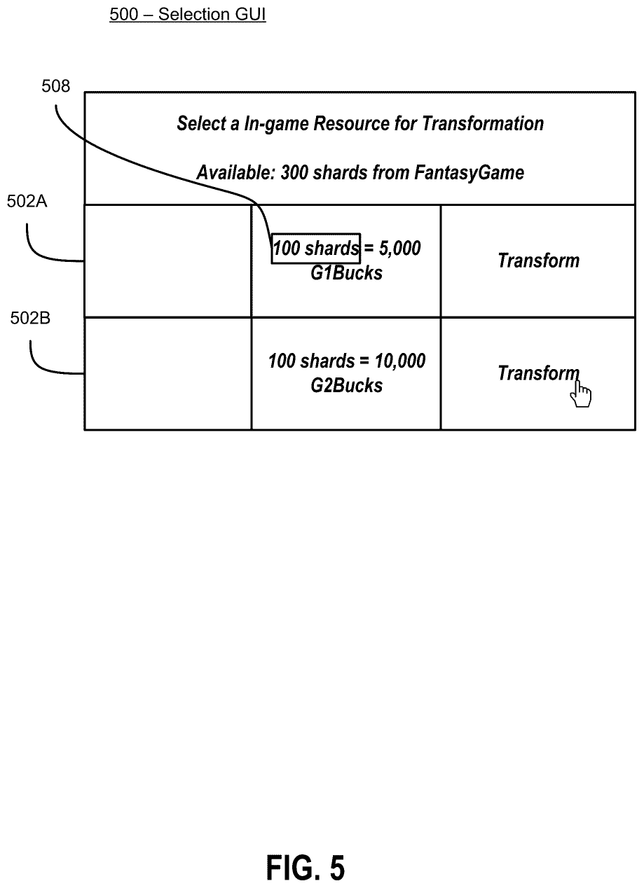

In some embodiments where connectivity platform 102 transforms an in-game resource from a different game into second in-game resource 112, connectivity platform 102 causes display of selection GUI 500 for selecting games in which to receive in-game resources. An example of such a GUI is illustrated in FIG. 5. Selection GUI 500 may include a game identifier 502A, 502B for one or more games into which an in-game resource from a different game may be transformed. For example, as depicted in FIG. 5, an in-game resource called “shards” from the game FantasyGame may be transformed into in-game resources for either Game 1 or Game 2 (G1Bucks and G2Bucks, respectively). In some implementations, the user may be logged into user account 120 when selection GUI 500 is presented to the user and may select a game for which the user wishes to receive an in-game resource (e.g., by clicking a transformation button using a mouse cursor, as illustrated in FIG. 5).

In such embodiments, in response to receiving such a selection from the user, connectivity platform 102 may determine the existence of an in-game account within the selected game associated with the user and/or user account 120. For example, the determination may be made by searching account database 124 stored in connectivity platform 102 using user account 120 (e.g., using text serving as a username for user account 120 as input for a search query of account database 124). Continuing with the same example, connectivity platform 102 may then identify a link between user account 120 and an in-game account for the selected game (e.g., by detecting that data representing user account 120 and the in-game account are linked/grouped together in account database 124). As another example, the determination may be made by receiving a credential (e.g., a password, username, biometric authenticator, security token, other personal identifier, or combination thereof) used by the game platform hosting the selected game to verify that an in-game account within the game is associated with the user inputting the credential (e.g., by transmitting the credential to the game platform via an API of the game platform and receiving a verification from that game platform that a certain in-game account within the game is associated with the user). Determining existence of the in-game account associated with user account 120 conserves computational resources across multiple transformation requests made by the user, as connectivity platform 102 may avoid determining the second transformation rate and executing a transformation which would ultimately fail because the user does not have an in-game account for the selected game.

### Example Computing Environment

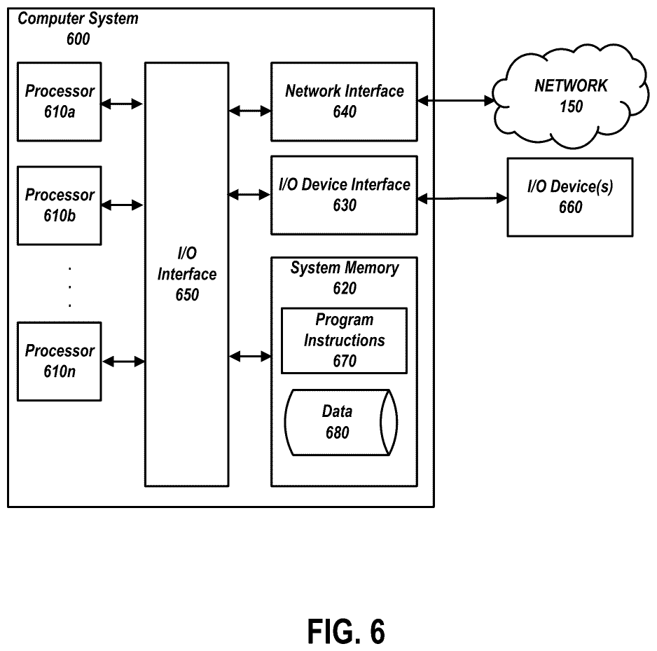

FIG. 6 shows an example computing system that may be used in accordance with some embodiments of this disclosure. In some instances, computing system 600 is referred to as a computer system 600. A person skilled in the art would understand that those terms may be used interchangeably. The components of FIG. 6 may be used to perform some or all operations discussed in relation to FIGS. 1-5. Furthermore, various portions of the systems and methods described herein may include or be executed on one or more computer systems similar to computing system 600. Further, processes and modules described herein may be executed by one or more processing systems similar to that of computing system 600.

Computing system 600 may include one or more processors (e.g., processors 610a-610n) coupled to system memory 620, an input/output (I/O) device interface 630, and a network interface 640 via an I/O interface 650. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 600. A processor may execute code (e.g., processor firmware, a protocol stack, a database management system, an operating system, or a combination thereof) that creates an execution environment for program instructions. A processor may include a programmable processor. A processor may include general or special-purpose microprocessors. A processor may receive instructions and data from a memory (e.g., system memory 620). Computing system 600 may be a uni-processor system including one processor (e.g., processor 610a) or a multi-processor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus may also be implemented as, special-purpose logic circuitry, e.g., an FPGA (field-programmable gate array) or an ASIC (application-specific integrated circuit). Computing system 600 may include a plurality of computing devices (e.g., distributed computer systems) to implement various processing functions.

I/O device interface 630 may provide an interface for connection of one or more I/O devices 660 to computer system 600. I/O devices may include devices that receive input (e.g., from a user) or output information (e.g., to a user). I/O devices 660 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computer system 600 through a wired or wireless connection. I/O devices 660 may be connected to computer system 600 from a remote location. I/O devices 660 located on remote computer systems, for example, may be connected to computer system 600 via a network and network interface 640.

Network interface 640 may include a network adapter that provides for connection of computer system 600 to a network. Network interface 640 may facilitate data exchange between computer system 600 and other devices connected to the network. Network interface 640 may support wired or wireless communication. The network may include an electronic communication network, such as the Internet, a local area network (LAN), a wide area network (WAN), a cellular communications network, or the like.

System memory 620 may be configured to store program instructions 670 or data. Program instructions 670 may be executable by a processor (e.g., one or more of processors 610a-610n) to implement one or more embodiments of the present techniques. Program instructions 670 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site or distributed across multiple remote sites and interconnected by a communication network.

System memory 620 may include a tangible program carrier having program instructions stored thereon. A tangible program carrier may include a non-transitory, computer-readable storage medium. A non-transitory, computer-readable storage medium may include a machine-readable storage device, a machine-readable storage substrate, a memory device, or any combination thereof. A non-transitory, computer-readable storage medium may include non-volatile memory (e.g., flash memory, ROM, PROM, EPROM, EEPROM), volatile memory (e.g., random-access memory (RAM), static random-access memory (SRAM), synchronous dynamic RAM (SDRAM)), bulk storage memory (e.g., CD-ROM and/or DVD-ROM, hard drives), or the like. System memory 620 may include a non-transitory, computer-readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices).

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 600 or multiple computer systems 600 configured to host different portions or instances of embodiments. Multiple computer systems 600 may provide for parallel or sequential processing/execution of one or more portions of the techniques described herein.

Those skilled in the art will appreciate that computer system 600 is merely illustrative and is not intended to limit the scope of the techniques described herein. Computer system 600 may include any combination of devices or software that may perform or otherwise provide for the performance of the techniques described herein. For example, computer system 600 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computer system 600 may also be connected to other devices that are not illustrated or may operate as a stand-alone system. In addition, the functionality provided by the illustrated components may, in some embodiments, be combined in fewer components or distributed in additional components. Similarly, in some embodiments, the functionality of some of the illustrated components may not be provided, or other additional functionality may be available.

### Blockchain Environment

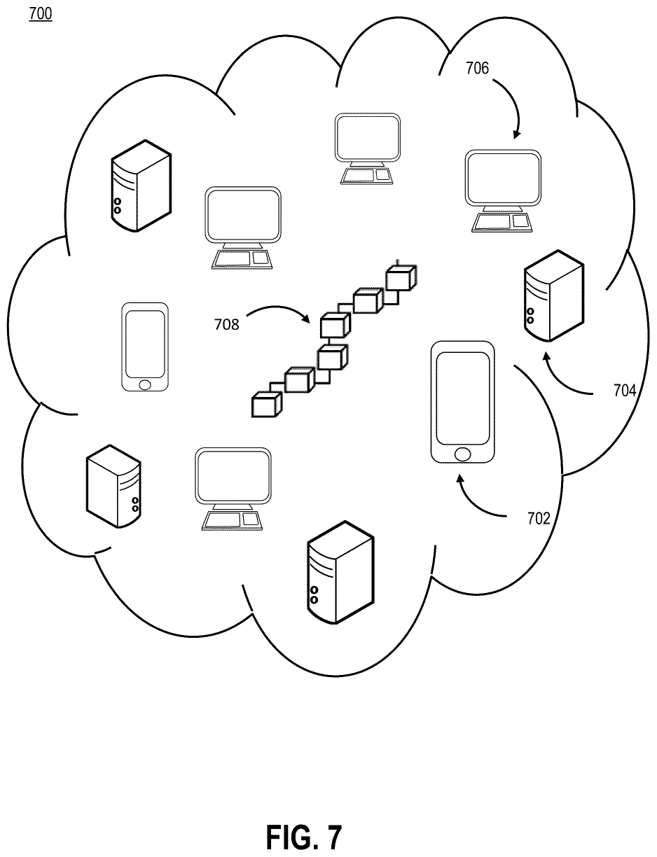

FIG. 7 shows an illustrative diagram for a decentralized environment for performing blockchain functions or operations, in accordance with one or more embodiments. For example, the diagram presents various components that may be used to allocate and distribute cryptographic resources in response to an off-chain trigger or event upon request in some embodiments.

As shown in FIG. 7, system 700 may include multiple user devices (e.g., user device 702, user device 704, and/or user device 706). For example, system 700 may include a distributed state machine in which each of the components in FIG. 7 acts as a client of system 700. For example, system 700 (as well as other systems described herein) may include a large data structure that holds not only all accounts and balances but also a state machine that may change from block to block according to a predefined set of rules and that may execute arbitrary machine code. The specific rules of changing state from block to block may be maintained by a virtual machine (e.g., a computer file implemented on and/or accessible by a user device, which behaves like an actual computer) for the system. For example, system 700 may interact with, and facilitate the function of, blockchain 708.

It should be noted that, while shown as a smartphone, a personal computer, and a server in FIG. 7, the user devices may be any type of computing device, including, but not limited to, a laptop computer, a tablet computer, a handheld computer, and/or other computing equipment (e.g., a server), including “smart,” wireless, wearable, and/or mobile devices. It should be noted that embodiments describing system 700 performing a blockchain function may equally be applied to, and correspond to, an individual user device (e.g., user device 702, user device 704, and/or user device 706) performing the blockchain function. That is, system 700 may correspond to the user devices (e.g., user device 702, user device 704, and/or user device 706) collectively or individually.

Each of the user devices may be used by the system to conduct blockchain functions or operations and/or contribute to allocating and distributing cryptographic resources in response to an off-chain trigger or event upon request. As referred to herein, “blockchain functions” or “blockchain operations” may include any operations including and/or related to blockchains and blockchain technology. For example, blockchain functions or operations may include conducting transactions, querying a distributed ledger, generating additional blocks for a blockchain, transmitting communications-related nonfungible tokens, performing encryption/decryption, exchanging public/private keys, and/or other operations related to blockchains and blockchain technology. In some embodiments, a blockchain function or operation may include the creation, modification, detection, and/or execution of a smart contract or program stored on a blockchain. For example, a smart contract may include a program stored on a blockchain that is executed (e.g., automatically, without any intermediary's involvement or time loss) when one or more predetermined conditions are met. In some embodiments, a blockchain function may include the creation, modification, exchange, and/or review of a token (e.g., a digital blockchain-specific asset), including a nonfungible token. A nonfungible token may include a token that is associated with a good, a service, a smart contract, and/or other content that may be verified by, and stored using, blockchain technology.

In some embodiments, blockchain functions or operations may also include actions related to mechanisms that facilitate other blockchain functions (e.g., actions related to metering activities for blockchain functions on a given blockchain network). For example, Ethereum, which is an open-source, globally decentralized computing infrastructure that executes smart contracts, uses a blockchain to synchronize and store the system's state changes. Ethereum uses a network-specific cryptocurrency called ether to meter and constrain execution resource costs. The metering mechanism is referred to as “gas.” As the system executes a smart contract, the system accounts for every blockchain function (e.g., computation, data access, transaction, etc.). Each blockchain function has a predetermined cost in units of gas (e.g., as determined based on a predefined set of rules for the system). When a blockchain function triggers the execution of a smart contract, the blockchain function may include an amount of gas that sets the upper limit of what may be consumed in running the smart contract. The system may terminate execution of the smart contract if the amount of gas consumed by computation exceeds the gas available in the blockchain function. For example, in Ethereum, gas includes a mechanism for enabling Turing-complete computation while limiting the resources that any smart contract and/or blockchain function may consume.

In some embodiments, gas may be obtained as part of a blockchain function or operation (e.g., a purchase) using a network-specific cryptocurrency (e.g., ether in the case of Ethereum). The system may require gas (or the amount of the network-specific cryptocurrency corresponding to the required amount of gas) to be transmitted with the blockchain function as an earmark to the blockchain function. In some embodiments, gas that is earmarked for a blockchain function may be refunded back to the originator of the blockchain function if, after the computation is executed, an amount remains unused.

As shown in FIG. 7, one or more user devices may include a digital wallet (e.g., a cryptography-based storage application described above) used to perform blockchain functions or operations. For example, the digital wallet may include a repository that allows users to store, manage, and trade their cryptocurrencies and assets, interact with blockchains, and/or conduct blockchain functions using one or more applications. The digital wallet may be specific to a given blockchain protocol or may provide access to multiple blockchain protocols. In some embodiments, the system may use various types of wallets, such as hot wallets and cold wallets. Hot wallets are connected to the Internet, while cold wallets are not. Most digital wallet holders hold both a hot wallet (e.g., residing on a computing device) and a cold wallet (residing on a device that is generally disconnected from a computing device and is not accessible until connected). Hot wallets are most often used to perform blockchain functions, while a cold wallet is generally used for managing a user account and may have no connection to the Internet.

One or more user devices may include a private key and a public key. In such cases, each pair includes a public key (e.g., which may be public) and a private key (e.g., which may be kept private). Key pairs may be generated using cryptographic algorithms (e.g., featuring one-way functions). Computing devices may then encrypt a message using an intended receiver's public key such that the encrypted message may be decrypted only with the receiver's corresponding private key. In some embodiments, a message may be used in combination with a private key to create a digital signature on the message. For example, the digital signature may be used to verify the authenticity of blockchain functions or operations. As an illustration, when conducting blockchain functions, the digital signature may be used to prove to every node in the system that it is authorized to conduct the blockchain functions.

For example, system 700 may include a plurality of nodes for the blockchain network. A node for a blockchain network may include an application or other software that records and/or monitors peer connections to other nodes and/or miners for the blockchain network. For example, a miner includes a node in a blockchain network that facilitates blockchain functions by verifying blockchain functions or operations on the blockchain, adding new blocks to the existing chain, and/or ensuring that these additions are accurate. The nodes may continually record the state of the blockchain and respond to remote procedure requests for information about the blockchain.

Following an authentication of the blockchain function, the blockchain function may be authorized. For example, after the blockchain function is authenticated between the users, system 700 may authorize the blockchain function prior to adding it to the blockchain. Blockchain functions or operations may be added to blockchain 708 via blockchain nodes. The blockchain may perform this (via blockchain nodes) based on a consensus within the blockchain network. For example, system 700 may rely on a majority (or other metric) of the nodes in the community network to determine that the blockchain function or operation is valid. In response to validation of the block, a blockchain node in the community network (e.g., a miner) may receive a reward (e.g., in a given cryptocurrency) as an incentive for validating the block.

To validate the blockchain function, a blockchain node may use one or more validation protocols and/or validation (or consensus) mechanisms. For example, a blockchain node may use a Proof of Work (POW) mechanism in which a user device must provide evidence that it performed computational work to validate a blockchain function, and thus this mechanism provides for achieving consensus in a decentralized manner as well as preventing fraudulent validations. For example, the POW may involve iterations of a hashing algorithm. The user device that is successful aggregates and records blockchain functions from a mempool (e.g., a collection of all valid blockchain functions waiting to be confirmed by the blockchain network) into the next block. Alternatively or additionally, a blockchain node may use a Proof of Stake (POS) mechanism in which a user account (e.g., corresponding to a node on the blockchain network) is required to have, or “stake,” a predetermined amount of tokens in order to be recognized as a validator in the blockchain network. In response to validation of the block, the block is added to blockchain 708, and the blockchain function is completed. For example, to add the blockchain function to blockchain 708, the successful node (e.g., the successful miner) encapsulates the blockchain function in a new block before committing it to the blockchain.

### Example Operation Flows

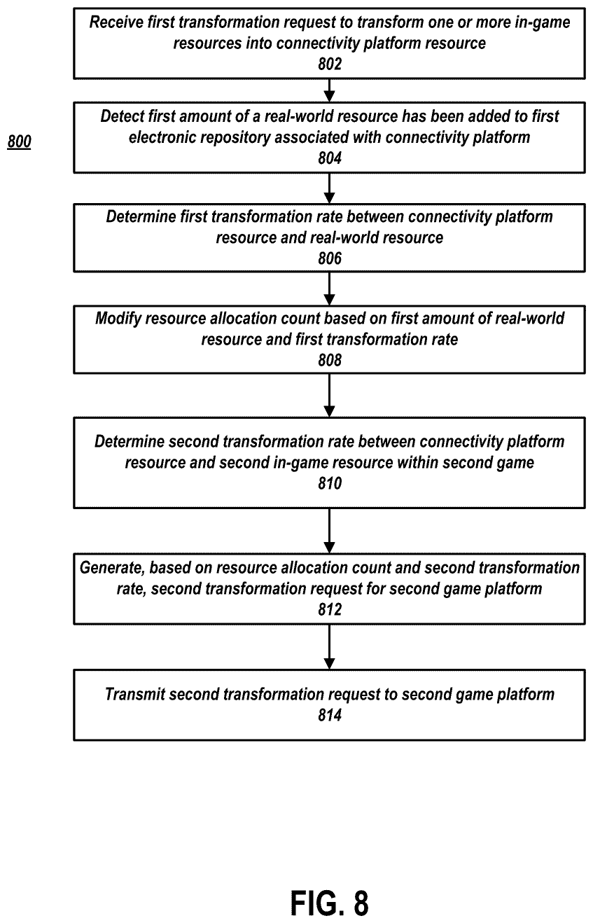

FIG. 8 is a flowchart of operations 800 for transforming in-game resources from one game into in-game resources in another game. The operations of FIG. 8 may use components described in relation to FIG. 6 and/or FIG. 7. In some embodiments, connectivity platform 102 may include one or more components of computer system 600. At 802, connectivity platform 102 receives a first transformation request to transform one or more in-game resources into a connectivity platform resource. For example, connectivity platform 102 may receive the first transformation request from a game platform using network interface 640 over network 150. In some embodiments, the first transformation request may be same as or generally similar to first transformation request 110.

At 804, connectivity platform 102 detects that a first amount of a real-world resource has been added to a first electronic repository associated with connectivity platform 102. For example, connectivity platform 102 may use one or more processors 610a, 610b, and/or 610n and/or network interface 640 to monitor the first electronic repository over network 150. As an additional example, connectivity platform 102 may use one or more processors 610a, 610b, and/or 610n and/or network interface 640 to receive a notification from the first electronic repository that a change in real-world resources within the first electronic repository has been made. In some embodiments, the real-world resource may be the same as or generally similar to real-world resource 116 and the first electronic repository may be the same as or generally similar to first electronic repository 106.

At 806, connectivity platform 102 determines a first transformation rate between a connectivity platform resource and the real-world resource. For example, connectivity platform 102 may use one or more processors 610a, 610b, and/or 610n and/or network interface 640 to receive information regarding the respective values of the connectivity platform resource and the real-world resource and to calculate the first transformation rate based on that information. In some embodiments, the real-world resource may be the same as or generally similar to real-world resource 116, the connectivity platform resource may be the same as or generally similar to connectivity platform resource 114, and the first electronic repository may be the same as or generally similar to first electronic repository 106.

At 808, connectivity platform 102 modifies a resource allocation count based on the first amount of the real-world resource and the first transformation rate. For example, connectivity platform 102 may use one or more processors 610a, 610b, and/or 610n to extract the first amount of the real-world resource and the first transformation rate from system memory 620 and store the modified resource allocation account in system memory 620. In some embodiments, the resource allocation count is increased based on the first amount of the real-world resource that was added to the first electronic repository and detected in 804. In these and other embodiments, the resource allocation count may indicate an amount of the connectivity platform resource attributed to a user account associated with a user of connectivity platform 102. The user account may be the same as or generally similar to user account 120.

At 810, connectivity platform 102 determines a second transformation rate between the connectivity platform resource and a second in-game resource within a second game. For example, connectivity platform 102 may use one or more processors 610a, 610b, and/or 610n and/or network interface 640 to receive information regarding the respective values of the connectivity platform resource and the second in-game resource and to calculate the second transformation rate based on that information.

At 812, connectivity platform 102 generates, based on the resource allocation count and the second transformation rate, a second transformation request for a second game platform to link an amount of the second in-game resource with a second in-game account associated with the user. For example, connectivity platform 102 may use one or more processors 610a, 610b, and/or 610n to extract the resource allocation count and the second transformation rate from system memory 620 and/or generate the second transformation request. In some embodiments, the second game platform may be the same as or generally similar to second game platform 104.

At 814, connectivity platform 102 transmits the second transformation request to the second game platform. For example, connectivity platform 102 may use one or more processors 610a, 610b, and/or 610n to and/or network interface 640 to transmit the transformation request over network 150.

Although the present invention has been described in detail for the purpose of illustration based on what is currently considered to be the most practical and preferred embodiments, it is to be understood that such detail is solely for that purpose and that the invention is not limited to the disclosed embodiments but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

I/We claim:

1. A system comprising:
at least one hardware processor; and
at least one non-transitory memory storing instructions, which, when executed by the at least one hardware processor, cause the system to:
receive, at a connectivity platform, a first transformation request to transform one or more in-game resources from a first game to one or more in-game resources in a second game, wherein the first transformation request comprises a first game identifier associated with the first game and an amount of a first in-game resource to transform;
detect that a first amount of a real-world resource has been added to a first electronic repository associated with the connectivity platform, wherein the first amount of the real-world resource was added to the first electronic repository in response to the first transformation request;
determine a first transformation rate between a connectivity platform resource and the real-world resource, wherein the connectivity platform resource is a token attributed to users of a connectivity platform and transformable into in-game resources for a plurality of games;
modify a resource allocation count based on the first amount of the real-world resource and the first transformation rate, wherein the resource allocation count indicates an amount of the connectivity platform resource attributed to a user account associated with a user within the connectivity platform;
determine a second transformation rate between the connectivity platform resource and a second in-game resource within the second game, wherein the second game is hosted by a second game platform;
generate, based on the resource allocation count and the second transformation rate, a second transformation request for the second game platform to link an amount of the second in-game resource with a second in-game account associated with the user, wherein the second transformation request comprises a specification of a type of the second in-game resource, the amount of the second in-game resource, the second in-game account, and the first electronic repository; and
transmit the second transformation request to a first application programming interface (API) of the second game platform, wherein the first API causes, in response to the second transformation request, a transfer of a second amount of the real-world resource from the first electronic repository to a second electronic repository that is associated with the second game platform.

2. The system of claim 1, further comprising instructions to:
receive, from the second game platform, a symbolic code generated in response to the second transformation request, wherein inputting the symbolic code into the second game platform while logged in to the second in-game account links the second in-game resource with the second in-game account; and
generate a presentation of the symbolic code to the user.

3. The system of claim 1, further comprising instructions to:
generate, based on the second in-game account, a transfer request to transfer the amount of the second in-game resource from a third in-game account associated with the connectivity platform to the second in-game account, wherein the transfer request comprises a specification of each of the amount of the second in-game resource, a first indication of the second in-game account, and a second indication of the third in-game account; and
transmit the transfer request to a second application programming interface (API) of the second game platform, wherein the second API causes, in response to the transfer request, the amount of the second in-game resource to be transferred from the third in-game account to the second in-game account.

4. The system of claim 1, wherein the second transformation rate is based on at least one of a number of selections of the second game or a transformation enhancement applied to the second game by the connectivity platform, and wherein the transformation enhancement is applied to the second game for a limited duration of time.

5. The system of claim 1, further comprising:
causing display of a graphical user interface (GUI) for transforming one or more resources, wherein the GUI includes a second game identifier associated with the first game and indicates at least one of the first transformation rate, the second transformation rate, a third transformation rate between the first in-game resource and the connectivity platform resource, or a fourth transformation rate between the first in-game resource and a third in-game resource, wherein the third in-game resource is a resource within a third game different from the first game.

6. The system of claim 5, wherein the graphical user interface (GUI) further comprises a list of games including the first game and an unlinked game for which the user does not have an existing in-game account, and wherein the unlinked game is selected from a games database within the connectivity platform based on at least one of a number of previous selections of the unlinked game, a transformation enhancement applied to the unlinked game by the connectivity platform, or a similarity between the unlinked game and a game for which the user does have an existing in-game account.

7. The system of claim 5, wherein the first transformation request is received from the user while the user is logged in to the user account, and wherein the first transformation request is received via a selection by the user of the second game identifier.

8. The system of claim 1, further comprising instructions to:
receive a notification that a third amount of a real-world resource has been added to the first electronic repository, wherein the first amount of the real-world resource was added to the first electronic repository in response to a transformation platform transforming a fourth amount of the real-world resource into a corresponding set of on-chain resources, and wherein the notification specifies (1) the fourth amount of the real-world resource and (2) a transformation platform account;
in response to receiving the notification, determine the user account is associated with the transformation platform account; and
modify the resource allocation count based on the fourth amount of the real-world resource and the first transformation rate.

9. The system of claim 1, further comprising instructions to:
cause display of a graphical user interface (GUI) for selecting an additional amount of the connectivity platform resource to receive;
receive, via the GUI, a selection from the user of the additional amount of the connectivity platform resource;
receive a notification that a third amount of a real-world resource has been added to the first electronic repository, wherein the third amount of the real-world resource was transferred to the first electronic repository based on the first transformation rate and the additional amount of the connectivity platform resource; and
in response to receiving the notification, modify the resource allocation count based on the additional amount of the connectivity platform resource.

10. The system of claim 1, further comprising instructions to:
modify the resource allocation count based on the second transformation rate and the amount of the second in-game resource; and
in response to modifying the resource allocation count, cause display of a graphical user interface (GUI) indicating the resource allocation count, the amount of the second in-game resource, and a spent connectivity platform resource count based on the modifying the resource allocation account.

11. The system of claim 1, wherein detecting that the first amount of the real-world resource has been added to the first electronic repository further comprises:
monitoring the first electronic repository for changes in real-world resources within the first electronic repository; and
detecting a change in real-world resources associated with the first transformation request, wherein detecting the change comprises identifying that the change is associated with the first game identifier and the amount of the first in-game resource.

12. The system of claim 1, wherein detecting that the first amount of the real-world resource has been added to the first electronic repository further comprises receiving a notification from the first electronic repository that a change in real-world resources within the first electronic repository has been made, wherein the notification includes an indication that the change is associated with the first game identifier and the amount of the first in-game resource.

13. The system of claim 1, wherein the first transformation request is received via a second application programming interface (API) of a first game platform, wherein the first game is hosted by the first game platform, and wherein the second API is accessed by the user while the user is logged in to a first in-game account for the first game.

14. A method, comprising:
receiving, at a connectivity platform, a first transformation request to transform one or more in-game resources into a connectivity platform resource, wherein the first transformation request comprises an amount of a first in-game resource to transform, and wherein the connectivity platform resource is a token attributed to users of a connectivity platform and transformable into in-game resources for a plurality of games;
detecting that a first amount of a real-world resource has been added to a first electronic repository associated with the connectivity platform, wherein the first amount of the real-world resource was added to the first electronic repository in response to the first transformation request;
determining a first transformation rate between the connectivity platform resource and the real-world resource;
modifying a resource allocation count based on the first amount of the real-world resource and the first transformation rate, wherein the resource allocation count indicates an amount of the connectivity platform resource attributed to a user account associated with a user within the connectivity platform;
determining a second transformation rate between the connectivity platform resource and a second in-game resource within a second game, wherein the second game is hosted by a second game platform;
generating, based on the resource allocation count and the second transformation rate, a second transformation request for the second game platform to link an amount of the second in-game resource with a second in-game account associated with the user; and
transmitting the second transformation request to the second game platform.

15. The method of claim 14, further comprising:
causing display of a graphical user interface (GUI) for selecting games in which to receive in-game resources, wherein the GUI indicates a second game identifier associated with the second game, and wherein the user is logged in to the user account within the connectivity platform when the GUI is presented to the user;
receiving, via the GUI, a selection of the second game from the user;
in response to receiving the selection of the second game from the user, determining existence of the second in-game account for the second game associated with the user account; and
based on determining the second in-game account, determining the second transformation rate.

16. The method of claim 14, wherein the first transformation request further comprises a first game identifier associated with a first game and the user account.

17. The method of claim 14, wherein the second transformation request comprises a specification of a type of the second in-game resource, the amount of the second in-game resource, the second in-game account, and the first electronic repository.

18. A non-transitory, computer-readable storage medium comprising instructions
recorded thereon, wherein the instructions, when executed by at least one data processor of a system, cause the system to:
receive, from a first game platform at a connectivity platform, a first transformation request to transform one or more in-game resources into a connectivity platform resource, wherein the first transformation request comprises an amount of a first in-game resource to transform, and wherein the connectivity platform resource is a token attributed to users of a connectivity platform and is transformable into in-game resources for a plurality of games;
detect that a first amount of a real-world resource has been added to a first electronic repository associated with the connectivity platform, wherein the first amount of the real-world resource was added to the first electronic repository in response to the first transformation request;
determine a first transformation rate between the connectivity platform resource and the real-world resource;
modify a resource allocation count based on the first amount of the real-world resource and the first transformation rate, wherein the resource allocation count indicates an amount of the connectivity platform resource attributed to a user account associated with a user within the connectivity platform;
determine a second transformation rate between the connectivity platform resource and a second in-game resource within a second game, wherein the second game is hosted by a second game platform;
generate, based on the resource allocation count and the second transformation rate, a second transformation request for the second game platform to link an amount of the second in-game resource with a second in-game account associated with the user; and
transmit the second transformation request to the second game platform.

19. The non-transitory, computer-readable storage medium of claim 18, wherein the instructions further cause the system to:
cause display of a graphical user interface (GUI) for selecting games in which to receive in-game resources, wherein the GUI indicates a second game identifier associated with the second game, and wherein the user is logged in to the user account within the connectivity platform when the GUI is presented to the user;
receive, via the GUI, a selection of the second game from the user;
in response to receiving the selection of the second game from the user, determine existence of a second in-game account for the second game associated with the user account; and
based on determining the second in-game account, determine the second transformation rate.

20. The non-transitory, computer-readable storage medium of claim 18, wherein the second transformation request comprises a specification of a type of the second in-game resource, the amount of the second in-game resource, the second in-game account, and the first electronic repository.
